(19) United States
(12) Patent Application Publication
(10) Pub. No.: US 2021/0197856 A1
(43) Pub. Date: Jul. 1, 2021

(54) IMAGE PROCESSING DEVICE, IMAGE PROCESSING METHOD, AND IMAGE PROCESSING SYSTEM

(71) Applicant: Mitsubishi Electric Corporation, Tokyo (JP)

(72) Inventors: Yumi HOSHINA, Tokyo (JP); Taro KUMAGAI, Tokyo (JP)

(73) Assignee: Mitsubishi Electric Corporation, Tokyo (JP)

(21) Appl. No.: 17/058,514

(22) PCT Filed: May 31, 2018
(86) PCT No.: PCT/JP2018/020992

§ 371 Date: Nov. 24, 2020

(51) Int. Cl. B60W 60/00; G05D 1/00; G06K 9/00

(52) U.S. Cl. CPC B60W 60/005; G05D 1/0061; G06K 9/00228; B60W 2540/229; G06K 9/00355; G06K 9/00382; B60W 2540/223; G06K 9/00845

(57) ABSTRACT

An image processing device includes: an image recognition unit for executing image recognition processing on an image captured by a camera for imaging a vehicle interior; and a threshold value setting unit for setting at least one threshold value among one or more threshold values to be used for the image recognition processing to a value being different depending on driving mode information.

### TECHNICAL FIELD

The present invention relates to an image processing device, an image processing method, and an image processing system.

### BACKGROUND ART

In related arts, systems have been developed which execute image recognition processing on an image captured by a camera for imaging the vehicle interior. The result of the image recognition processing is used, for example, to determine whether or not a passenger is in an abnormal state (see, for example, Patent Literature 1).

### CITATION LIST

### Patent Literature

Patent Literature 1: JP 2017-146744 A

### SUMMARY OF INVENTION

### Technical Problem

In recent years, technological development related to so-called “autonomous driving” has been made. Along with this, it is desired to implement image recognition processing in accordance with the driving mode of a vehicle. For example, when a vehicle is set to a manual driving mode, it is desired to implement image recognition processing in which the accuracy of determination of whether or not a passenger is in an abnormal state is enhanced and the number of times of execution of the abnormality determination (that is, execution frequency of the abnormality determination) is reduced. That is, in the manual driving mode, it is desired to prevent excessive detection of an abnormal state and to reduce output of unnecessary alarms. On the other hand, when the vehicle is set to an autonomous driving mode, it is desired to implement image recognition processing in which the number of times of execution of the abnormality determination (that is, execution frequency of the abnormality determination) is increased by reducing the accuracy of the determination so that it is possible to switch from the autonomous driving mode to the manual driving mode at any time when the switching is required. That is, in the autonomous driving mode, it is desired to prevent detection failures of an abnormal state and not to overlook an abnormal state.

The present invention has been made to solve the above problems, and an object of the invention is to provide an image processing device, an image processing method, and an image processing system that can implement image recognition processing in accordance with a driving mode of a vehicle.

### Solution to Problem

An image processing device of the present invention includes: an image recognition unit executing image recognition processing on an image captured by a camera for imaging an interior of a vehicle; and a threshold value setting unit setting at least one threshold value among one or more threshold values to be used for the image recognition processing to a value being different depending on driving mode information.

### Advantageous Effects of Invention

According to the present invention, with the above configuration, it is possible to implement image recognition processing in accordance with the driving mode of a vehicle.

### BRIEF DESCRIPTION OF DRAWINGS

FIG. 1 is a block diagram illustrating a state in which an image processing system according to a first embodiment is installed in a vehicle.

FIG. 2A is a block diagram illustrating a hardware configuration of a control device according to the first embodiment. FIG. 2B is a block diagram illustrating another hardware configuration of the control device according to the first embodiment.

FIG. 3A is a flowchart illustrating an operation of an image processing device according to the first embodiment. FIG. 3B is a flowchart illustrating another operation of the image processing device according to the first embodiment. FIG. 3C is a flowchart illustrating another operation of the image processing device according to the first embodiment. FIG. 3D is a flowchart illustrating another operation of the image processing device according to the first embodiment.

FIG. 4A is a flowchart illustrating another operation of the image processing device according to the first embodiment. FIG. 4B is a flowchart illustrating another operation of the image processing device according to the first embodiment.

FIG. 5A is a flowchart illustrating another operation of the image processing device according to the first embodiment. FIG. 5B is a flowchart illustrating another operation of the image processing device according to the first embodiment. FIG. 5C is a flowchart illustrating another operation of the image processing device according to the first embodiment. FIG. 5D is a flowchart illustrating another operation of the image processing device according to the first embodiment.

FIG. 6 is a flowchart illustrating another operation of the image processing device according to the first embodiment.

FIG. 7A is an explanatory diagram illustrating an example of a captured image and a face area. FIG. 7B is an explanatory diagram illustrating another example of a captured image and a face area. FIG. 7C is an explanatory diagram illustrating another example of a captured image and a face area. FIG. 7D is an explanatory diagram illustrating another example of a captured image and a face area.

FIG. 8 is a block diagram illustrating a state in which another image processing system according to the first embodiment is installed in a vehicle.

FIG. 9 is a block diagram illustrating a state in which an image processing system according to a second embodiment is installed in a vehicle.

FIG. 10 is a block diagram illustrating a state in which an image processing system according to a third embodiment is installed in a vehicle.

FIG. 11 is a block diagram illustrating a state in which another image processing system according to the third embodiment is installed in a vehicle.

### DESCRIPTION OF EMBODIMENTS

In order to describe the present invention further in detail, embodiments for carrying out the invention will be described below with reference to the accompanying drawings.

### First Embodiment

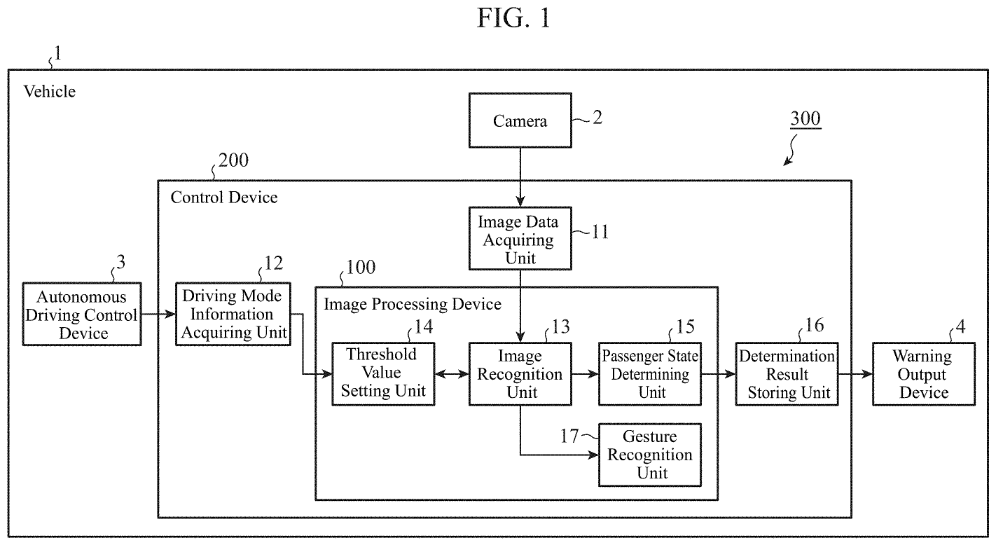

FIG. 1 is a block diagram illustrating a state in which an image processing system according to a first embodiment is installed in a vehicle. An image processing system 300 according to the first embodiment will be described with reference to FIG. 1.

A vehicle 1 includes a camera 2 for imaging the vehicle interior. The camera 2 includes, for example, an infrared camera or a visible light camera. The camera 2 is installed, for example, in the dashboard of the vehicle 1 (more specifically, in the center cluster). Hereinafter, a passenger to be imaged by the camera 2 is simply referred to as a “passenger”. That is, a passenger may be a driver.

The vehicle 1 has a function of autonomous driving. That is, the vehicle 1 can travel in any of a manual driving mode or an autonomous driving mode. An autonomous driving control device 3 executes control for switching the driving mode of the vehicle 1. The autonomous driving control device 3 executes control for causing the vehicle 1 to travel when the vehicle 1 is set in the autonomous driving mode.

An image data acquiring unit 11 acquires, from the camera 2, image data indicating an image captured by the camera 2 (hereinafter, simply referred to as “captured image”). The image data acquiring unit 11 outputs the acquired image data to an image recognition unit 13.

A driving mode information acquiring unit 12 acquires information about the driving mode of the vehicle 1 (hereinafter referred to as “driving mode information”) from the autonomous driving control device 3. The driving mode information indicates, for example, whether the vehicle 1 is set to the manual driving mode or the autonomous driving mode. The driving mode information acquiring unit 12 outputs the acquired driving mode information to a threshold value setting unit 14.

The image recognition unit 13 executes multiple types of image recognition processing on the captured image using the image data output by the image data acquiring unit 11. In each of the multiple of types of image recognition processing, one or more threshold values Th are used. The threshold value setting unit 14 sets these threshold values Th. Hereinafter, specific examples of the image recognition processing and threshold values Th will be described.

First, the image recognition unit 13 executes a process of detecting an area that corresponds to the face of a passenger in the captured image (hereinafter referred to as a “face area”). Next, the image recognition unit 13 executes a process of determining the success or failure of the detection. In a case where the detection is successful, the image recognition unit 13 executes the process of calculating the reliability R of the detection result, and executes the process of determining whether the reliability R is large or small. Hereinafter, these processes are collectively referred to as the “face area detecting process”. The threshold value setting unit 14 sets, before the face area detecting process is executed, a threshold value for the detection (hereinafter referred to as a “detection threshold value”) Th1, a threshold value for determination of success or failure (hereinafter referred to as a “success or failure determination threshold value”) Th2, and a threshold value to be compared with the reliability R (hereinafter referred to as a “reliability determination threshold value”) Th3.

Various known algorithms can be used for the face area detecting process, and detailed description of these algorithms is omitted. The threshold values Th1, Th2, and Th3 for the face area detecting process are set depending on the algorithms for the face area detecting process. The reliability R of the detection result in the face area detecting process varies depending on various factors such as the contrast difference in the face area, whether or not there is a shielding object covering the passenger's face (e.g. the passenger's hand or food and drink), or whether or not the passenger is wearing an item (e.g. a mask, a hat, or a muffler).

The image recognition unit 13 further executes a process of detecting a plurality of feature points (hereinafter referred to as the “face feature points”) corresponding to each of face parts (for example, the right eye, left eye, right eyebrow, left eyebrow, nose, and mouth) using the result of the face area detecting process. Next, the image recognition unit 13 executes a process of determining the success or failure of the detection. In a case where the detection is successful, the image recognition unit 13 executes the process of calculating the reliability R of the detection result, and executes the process of determining whether the reliability R is large or small. Hereinafter, these processes are collectively referred to as the “face feature point detecting process”. The threshold value setting unit 14 sets, before the face feature point detecting process is executed, a threshold value for the detection (hereinafter referred to as a “detection threshold value”) Th1, a threshold value for determination of success or failure (hereinafter referred to as a “success or failure determination threshold value”) Th2, and a threshold value to be compared with the reliability R (hereinafter referred to as a “reliability determination threshold value”) Th3.

Various known algorithms can be used for the face feature point detecting process, and detailed description of these algorithms is omitted. The threshold values Th1, Th2, and Th3 for the face feature point detecting process are set depending on the algorithms for the face feature point detecting process. The reliability R of the detection result in the face feature point detecting process varies depending on various factors such as the contrast differences in areas corresponding to respective face parts in the face area, whether or not there is a shielding object covering the passenger's face (e.g. the passenger's hand or food and drink), or whether or not the passenger is wearing an item (e.g. sunglasses or a mask).

The image recognition unit 13 executes a process of detecting the eye opening degree of the passenger using the result of the face feature point detecting process. Next, the image recognition unit 13 executes a process of determining the success or failure of the detection. In a case where the detection is successful, the image recognition unit 13 executes the process of calculating the reliability R of the detection result, and executes the process of determining whether the reliability R is large or small. Hereinafter, these processes are collectively referred to as the “eye opening degree detecting process”. The threshold value setting unit 14 sets, before the eye opening degree detecting process is executed, a threshold value for the detection (hereinafter referred to as a “detection threshold value”) Th1, a threshold value for determination of success or failure (hereinafter referred to as a “success or failure determination threshold value”) Th2, and a threshold value to be compared with the reliability R (hereinafter referred to as a “reliability determination threshold value”) Th3.

Various known algorithms can be used for the eye opening degree detecting process, and detailed description of these algorithms is omitted. The threshold values Th1, Th2, and Th3 for the eye opening degree detecting process are set depending on the algorithms for the eye opening degree detecting process. The reliability R of the detection result in the eye opening degree detecting process varies depending on various factors such as whether or not the passenger is wearing eyeglasses or sunglasses on the face, whether or not there is light reflected by the eyeglasses or the sunglasses, or whether or not there is reflection of a landscape on the eyeglasses or the sunglasses.

The image recognition unit 13 further executes a process of detecting the angle of the face orientation of the passenger using the result of the face feature point detecting process. Next, the image recognition unit 13 executes a process of determining the success or failure of the detection. In a case where the detection is successful, the image recognition unit 13 executes the process of calculating the reliability R of the detection result, and executes the process of determining whether the reliability R is large or small. Hereinafter, these processes are collectively referred to as the “face orientation detecting process”. The threshold value setting unit 14 sets, before the face orientation detecting process is executed, a threshold value for the detection (hereinafter referred to as a “detection threshold value”) Th1, a threshold value for determination of success or failure (hereinafter referred to as a “success or failure determination threshold value”) Th2, and a threshold value to be compared with the reliability R (hereinafter referred to as a “reliability determination threshold value”) Th3.

Various known algorithms can be used for the face orientation detecting process, and detailed description of these algorithms is omitted. The threshold values Th1, Th2, and Th3 for the face orientation detecting process are set depending on the algorithms for the face orientation detecting process. The reliability R of the detection result in the face orientation detecting process varies depending on various factors such as whether or not the passenger is wearing an item (e.g. a mask, a hat, or a muffler).

The image recognition unit 13 further executes a process of detecting an area that corresponds to a hand of a passenger in the captured image (hereinafter referred to as a “hand area”). Next, the image recognition unit 13 executes a process of determining the success or failure of the detection. In a case where the detection is successful, the image recognition unit 13 executes the process of calculating the reliability R of the detection result, and executes the process of determining whether the reliability R is large or small. Hereinafter, these processes are collectively referred to as the “hand area detecting process”. The threshold value setting unit 14 sets, before the hand area detecting process is executed, a threshold value for the detection (hereinafter referred to as a “detection threshold value”) Th1, a threshold value for determination of success or failure (hereinafter referred to as a “success or failure determination threshold value”) Th2, and a threshold value to be compared with the reliability R (hereinafter referred to as a “reliability determination threshold value”) Th3.

Various known algorithms can be used for the hand area detecting process, and detailed description of these algorithms is omitted. The threshold values Th1, Th2, and Th3 for the hand area detecting process are set depending on the algorithms for the hand area detecting process. The reliability R of the detection result in the hand area detecting process varies depending on various factors.

The image recognition unit 13 further executes a process of detecting a plurality of feature points (hereinafter referred to as “hand feature points”) corresponding to respective hand parts (for example, thumb, index finger, middle finger, ring finger, little finger, and palm) using the result of the hand area detecting process. Next, the image recognition unit 13 executes a process of determining the success or failure of the detection. In a case where the detection is successful, the image recognition unit 13 executes the process of calculating the reliability R of the detection result, and executes the process of determining whether the reliability R is large or small. Hereinafter, these processes are collectively referred to as the “hand feature point detecting process”. The threshold value setting unit 14 sets, before the hand feature point detecting process is executed, a threshold value for the detection (hereinafter referred to as a “detection threshold value”) Th1, a threshold value for determination of success or failure (hereinafter referred to as a “success or failure determination threshold value”) Th2, and a threshold value to be compared with the reliability R (hereinafter referred to as a “reliability determination threshold value”) Th3.

Various known algorithms can be used for the hand feature point detecting process, and detailed description of these algorithms is omitted. The threshold values Th1, Th2, and Th3 for the hand feature point detecting process are set depending on the algorithms for the hand feature point detecting process. The reliability R of the detection result in the hand feature point detecting process varies depending on various factors.

The image recognition unit 13 also executes a process of detecting the posture of a hand of the passenger using the result of the hand feature point detecting process. Next, the image recognition unit 13 executes a process of determining the success or failure of the detection. In a case where the detection is successful, the image recognition unit 13 executes the process of calculating the reliability R of the detection result, and executes the process of determining whether the reliability R is large or small. Hereinafter, these processes are collectively referred to as the “hand posture detecting process”. The threshold value setting unit 14 sets, before the hand posture detecting process is executed, a threshold value for the detection (hereinafter referred to as a “detection threshold value”) Th1, a threshold value for determination of success or failure (hereinafter referred to as a “success or failure determination threshold value”) Th2, and a threshold value to be compared with the reliability R (hereinafter referred to as a “reliability determination threshold value”) Th3.

Various known algorithms can be used for the hand posture detecting process, and detailed description of these algorithms is omitted. The threshold values Th1, Th2, and Th3 for the hand posture detecting process are set depending on the algorithms for the hand posture detecting process. The reliability R of the detection result in the hand posture detecting process varies depending on various factors.

The image recognition unit 13 also executes a process of detecting the motion of the hand of the passenger using the result of the hand feature point detecting process. Next, the image recognition unit 13 executes a process of determining the success or failure of the detection. In a case where the detection is successful, the image recognition unit 13 executes the process of calculating the reliability R of the detection result, and executes the process of determining whether the reliability R is large or small. Hereinafter, these processes are collectively referred to as the “hand motion detecting process”. The threshold value setting unit 14 sets, before the hand motion detecting process is executed, a threshold value for the detection (hereinafter referred to as a “detection threshold value”) Th1, a threshold value for determination of success or failure (hereinafter referred to as a “success or failure determination threshold value”) Th2, and a threshold value to be compared with the reliability R (hereinafter referred to as a “reliability determination threshold value”) Th3.

Various known algorithms can be used for the hand motion detecting process, and detailed description of these algorithms is omitted. The threshold values Th1, Th2, and Th3 for the hand motion detecting process are set depending on the algorithms for the hand motion detecting process. The reliability R of the detection result in the hand motion detecting process varies depending on various factors.

Here, the threshold value setting unit 14 sets at least one threshold value Th (for example, the reliability determination threshold value Th3) among one or more threshold values Th (for example, the detection threshold value Th1, the success or failure determination threshold value Th2, and the reliability determination threshold value Th3) to a value being different depending on the driving mode information output by the driving mode information acquiring unit 12.

Specifically, for example in a case where the vehicle 1 is set to the autonomous driving mode, the threshold value setting unit 14 sets the reliability determination threshold value Th3 to a smaller value than that in a case where the vehicle 1 is set to the manual driving mode. That is, the reliability determination threshold values Th3 are each selectively set to one of two values.

Note that the face feature point detecting process is executed only when it is determined in the face area detecting process that the reliability R of the detection result is greater than the reliability determination threshold value Th3. The eye opening degree detecting process is executed only when it is determined in the face feature point detecting process that the reliability R of the detection result is greater than the reliability determination threshold value Th3. The face orientation detecting process is executed only when it is determined in the face feature point detecting process that the reliability R of the detection result is greater than the reliability determination threshold value Th3.

Note that the hand feature point detecting process is executed only when it is determined in the hand area detecting process that the reliability R of the detection result is greater than the reliability determination threshold value Th3. The hand posture detecting process is executed only when it is determined in the hand feature point detecting process that the reliability R of the detection result is greater than the reliability determination threshold value Th3. The hand motion detecting process is executed only when it is determined in the hand feature point detecting process that the reliability R of the detection result is greater than the reliability determination threshold value Th3.

The passenger state determining unit 15 executes process of determining whether or not the passenger is in an abnormal state (hereinafter, referred to as the “passenger state determining processing”) using the result of the image recognition processing by the image recognition unit 13 (more specifically, the eye opening degree detecting process or the face orientation detecting process).

Specifically, for example, the passenger state determining unit 15 executes a process of determining whether or not the passenger is in a dozing state (hereinafter referred to as the “dozing state determining process”) using the result of the eye opening degree detecting process. Various known algorithms can be used for the dozing state determining process, and detailed description of these algorithms is omitted.

Furthermore, for example, the passenger state determining unit 15 executes a process of determining whether or not the passenger is in an inattentive state (hereinafter referred to as the “inattentive state determining process”) using the result of the face orientation detecting process. Various known algorithms can be used for the inattentive state determining process, and detailed description of these algorithms is omitted.

Here, the dozing state determining process is executed only when it is determined in the eye opening degree detecting process that the reliability R of the detection result is greater than the reliability determination threshold value Th3. The inattentive state determining process is executed only when it is determined in the face orientation detecting process that the reliability R of the detection result is greater than the reliability determination threshold value Th3.

The determination result storing unit 16 stores information indicating the determination result by the passenger state determining unit 15 (hereinafter referred to as “determination result information”). The determination result information includes, for example, information indicating whether or not the passenger is in a dozing state, information indicating the drowsiness level of the passenger that is calculated in the dozing state determining process, information indicating whether or not the passenger is in an inattentive state, and information indicating the angle of the face orientation of the passenger used in the inattentive state determining process.

The warning output device 4 outputs a warning when the determination result information indicating that the passenger is in an abnormal state is stored in the determination result storing unit 16. Specifically, for example, the warning output device 4 displays a warning image or outputs a warning sound. The warning output device 4 includes, for example, a display or a speaker.

The gesture recognition unit 17 executes a process of recognizing hand gesture by the passenger (hereinafter, referred to as the “gesture recognition process”) using the result of the image recognition processing (more specifically, the hand posture detecting process and the hand motion detecting process) by the image recognition unit 13. Various known algorithms can be used for the gesture recognition process, and detailed description of these algorithms is omitted.

Here, the gesture recognition process is executed only when it is determined in the hand posture detecting process that the reliability R of the detection result is greater than the reliability determination threshold value Th3, and when it is determined that the reliability R of the detection result is greater than the reliability determination threshold value Th3 in the hand motion detecting process.

The image recognition unit 13, the threshold value setting unit 14, the passenger state determining unit 15, and the gesture recognition unit 17 are included in the main part of the image processing device 100. The image data acquiring unit 11, the driving mode information acquiring unit 12, the determination result storing unit 16, and the image processing device 100 are included in the main part of the control device 200. The camera 2 and the control device 200 are included in the main part of the image processing system 300.

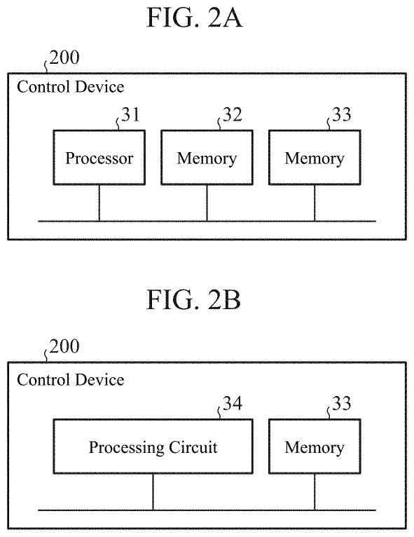

Next, hardware configurations of the main part of the control device 200 will be described with reference to FIG. 2.

As illustrated in FIG. 2A, the control device 200 includes a computer, and the computer includes a processor 31 and memories 32 and 33. The memory 32 stores programs for causing the computer to function as the image data acquiring unit 11, the driving mode information acquiring unit 12, the image recognition unit 13, the threshold value setting unit 14, the passenger state determining unit 15, and the gesture recognition unit 17. The functions of the image data acquiring unit 11, the driving mode information acquiring unit 12, the image recognition unit 13, the threshold value setting unit 14, the passenger state determining unit 15, and the gesture recognition unit 17 are implemented by the processor 31 reading and executing the programs stored in the memory 32. The function of the determination result storing unit 16 is implemented by the memory 33.

Alternatively, as illustrated in FIG. 2B, the control device 200 may include a memory 33 and a processing circuit 34. In this case, the functions of the image data acquiring unit 11, the driving mode information acquiring unit 12, the image recognition unit 13, the threshold value setting unit 14, the passenger state determining unit 15, and the gesture recognition unit 17 may be implemented by the processing circuit 34.

Further alternatively, the control device 200 may include the processor 31, the memories 32 and 33, and the processing circuit 34 (not illustrated). In this case, some of the functions of the image data acquiring unit 11, the driving mode information acquiring unit 12, the image recognition unit 13, the threshold value setting unit 14, the passenger state determining unit 15, and the gesture recognition unit 17 may be implemented by the processor 31 and the memory 32, and the remaining functions may be implemented by the processing circuit 34.

The processor 31 includes, for example, a central processing unit (CPU), a graphics processing unit (GPU), a microprocessor, a micro controller, or a digital signal processor (DSP).

The memories 32 and 33 include, for example, semiconductor memories or magnetic disks. More specifically, the memory 32 includes, for example, a random access memory (RAM), a read only memory (ROM), a flash memory, an erasable programmable read only memory (EPROM), an electrically erasable programmable read-only memory (EEPROM), a solid state drive (SSD), or a hard disk drive (HDD).

The processing circuit 34 includes, for example, an application specific integrated circuit (ASIC), a programmable logic device (PLD), a field-programmable gate array (FPGA), a system-on-a-chip (SoC), or a system large-scale integration (LSI).

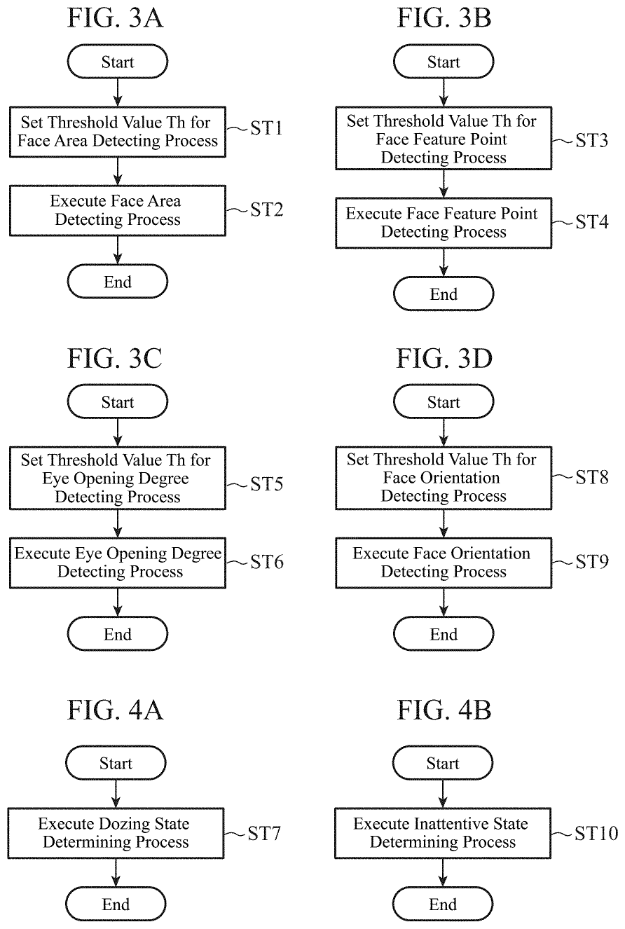

Next, with reference to the flowcharts of FIGS. 3 and 4, the operation of the image processing device 100 will be described.

The image processing device 100 starts the process of step ST1 illustrated in FIG. 3A when, for example, image data is output by the image data acquiring unit 11. Note that it is assumed that the driving mode information is output by the driving mode information acquiring unit 12 before the process of step ST1 is started.

First, in step ST1, the threshold value setting unit 14 sets one or more threshold values Th for the face area detecting process (for example, the detection threshold value Th1, the success or failure determination threshold value Th2, and the reliability determination threshold value Th3). At this point, the threshold value setting unit 14 sets at least one of these threshold values Th (for example, the reliability determination threshold value Th3) to a value being different depending on the driving mode information.

Next, in step ST2, the image recognition unit 13 executes the face area detecting process. In the face area detecting process in step ST2, the at least one threshold value Th set in step ST1 is used.

If it is determined in the face area detecting process of step ST2 that the reliability R of the detection result is greater than the reliability determination threshold value Th3, in step ST3, the threshold value setting unit 14 sets one or more threshold values Th for the face feature point detecting process (for example, the detection threshold value Th1, the success or failure determination threshold value Th2, and the reliability determination threshold value Th3). At this point, the threshold value setting unit 14 sets at least one of these threshold values Th (for example, the reliability determination threshold value Th3) to a value being different depending on the driving mode information.

Next, in step ST4, the image recognition unit 13 executes the face feature point detecting process. In the face feature point detecting process of step ST4, the detection result of the face area detecting process of step ST2 is used, and the threshold values Th set in step ST3 are also used.

If it is determined in the face feature point detecting process of step ST4 that the reliability R of the detection result is greater than the reliability determination threshold value Th3, the threshold value setting unit 14 sets, in step ST5, one or more threshold values Th for the eye opening degree detecting process (for example, the detection threshold value Th1, the success or failure determination threshold value Th2, and the reliability determination threshold value Th3). At this point, the threshold value setting unit 14 sets at least one of these threshold values Th (for example, the reliability determination threshold value Th3) to a value being different depending on the driving mode information.

Next, in step ST6, the image recognition unit 13 executes the eye opening degree detecting process. In the eye opening degree detecting process of step ST6, the detection result of the face feature point detecting process of step ST4 is used, and the threshold values Th set in step ST5 are also used.

If it is determined in the eye opening degree detecting process in step ST6 that the reliability R of the detection result is greater than the reliability determination threshold value Th3, the passenger state determining unit 15 executes the dozing state determining process in step ST7. In the dozing state determining process of step ST7, the detection result of the eye opening degree detecting process of step ST6 is used.

Furthermore, if it is determined in the face feature point detecting process of step ST4 that the reliability R of the detection result is greater than the reliability determination threshold value Th3, in step ST8, the threshold value setting unit 14 sets one or more threshold values Th for the face orientation detecting process (for example, the detection threshold value Th1, the success or failure determination threshold value Th2, and the reliability determination threshold value Th3). At this point, the threshold value setting unit 14 sets at least one of these threshold values Th (for example, the reliability determination threshold value Th3) to a value being different depending on the driving mode information.

Next, in step ST9, the image recognition unit 13 executes the face orientation detecting process. In the face orientation detecting process of step ST9, the detection result of the face feature point detecting process of step ST4 is used, and the threshold values Th set in step ST8 are also used.

If it is determined in the face orientation detecting process in step ST9 that the reliability R of the detection result is greater than the reliability determination threshold value Th3, the passenger state determining unit 15 executes the inattentive state determining process in step ST10. In the inattentive state determining process of step ST10, the detection result of the eye opening degree detecting process of step ST9 is used.

Note that if it is determined in the face area detecting process in step ST2 that the reliability R of the detection result is less than or equal to the reliability determination threshold value Th3, the process of step ST3 and subsequent processes (that is, processes of steps ST3 to ST10) are not executed.

If it is determined in the face feature point detecting process in step ST4 that the reliability R of the detection result is less than or equal to the reliability determination threshold value Th3, the processes of step ST5 and subsequent processes (that is, the processes of steps ST5 to ST10) are not executed.

Moreover, if it is determined in the eye opening degree detecting process in step ST6 that the reliability R of the detection result is less than or equal to the reliability determination threshold value Th3, the process of step ST7 is not executed.

Moreover, if it is determined in the face orientation detecting process in step ST9 that the reliability R of the detection result is less than or equal to the reliability determination threshold value Th3, the process of step ST10 is not executed.

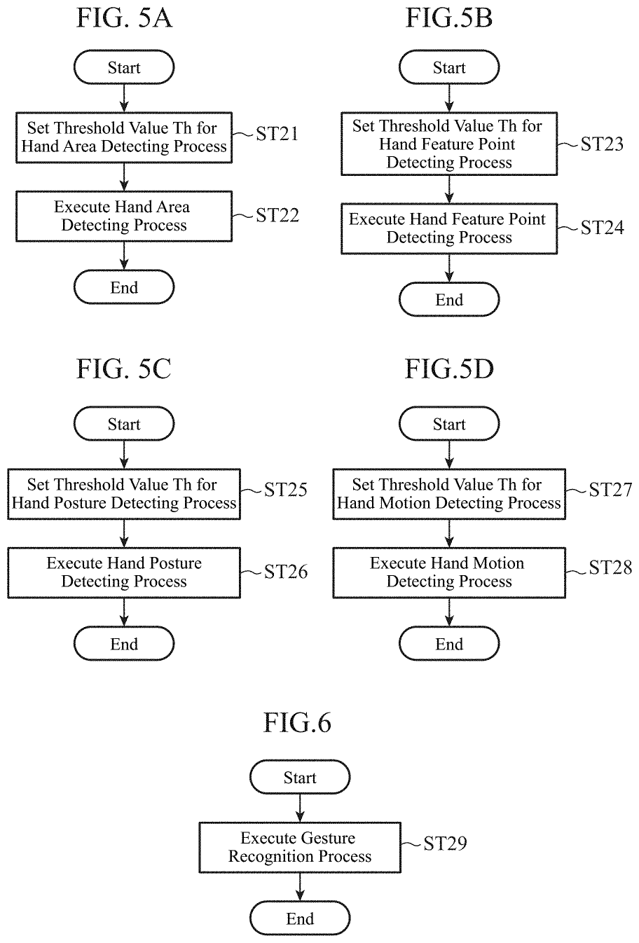

Next, with reference to the flowcharts of FIGS. 5 and 6, other operations of the image processing device 100 will be described.

The image processing device 100 starts the process of step ST21 illustrated in FIG. 5A, for example, when image data is output by the image data acquiring unit 11. Note that it is assumed that the driving mode information is output by the driving mode information acquiring unit 12 before the process of step ST21 is started.

First, in step ST21, the threshold value setting unit 14 sets one or more threshold values Th for the hand area detecting process (for example, the detection threshold value Th1, the success or failure determination threshold value Th2, and the reliability determination threshold value Th3). At this point, the threshold value setting unit 14 sets at least one of these threshold values Th (for example, the reliability determination threshold value Th3) to a value being different depending on the driving mode information.

Next, in step ST22, the image recognition unit 13 executes the hand area detecting process. In the hand area detecting process in step ST22, the at least one threshold value Th set in step ST21 is used.

If it is determined in the hand area detecting process of step ST22 that the reliability R of the detection result is greater than the reliability determination threshold value Th3, in step ST23, the threshold value setting unit 14 sets one or more threshold values Th for the hand feature point detecting process (for example, the detection threshold value Th1, the success or failure determination threshold value Th2, and the reliability determination threshold value Th3). At this point, the threshold value setting unit 14 sets at least one of these threshold values Th (for example, the reliability determination threshold value Th3) to a value being different depending on the driving mode information.

Next, in step ST24, the image recognition unit 13 executes the hand feature point detecting process. In the hand feature point detecting process of step ST24, the detection result of the hand area detecting process of step ST22 is used, and the threshold values Th set in step ST23 are also used.

If it is determined in the hand feature point detecting process of step ST24 that the reliability R of the detection result is greater than the reliability determination threshold value Th3, in step ST25, the threshold value setting unit 14 sets one or more threshold values Th for the hand posture detecting process (for example, the detection threshold value Th1, the success or failure determination threshold value Th2, and the reliability determination threshold value Th3). At this point, the threshold value setting unit 14 sets at least one of these threshold values Th (for example, the reliability determination threshold value Th3) to a value being different depending on the driving mode information.

Next, in step ST26, the image recognition unit 13 executes the hand posture detecting process. In the hand posture detecting process of step ST26, the detection result of the hand feature point detecting process of step ST24 is used, and the threshold values Th set in step ST25 are also used.

Furthermore, if it is determined in the hand feature point detecting process of step ST24 that the reliability R of the detection result is greater than the reliability determination threshold value Th3, the threshold value setting unit 14 sets, in step ST27, one or more threshold values Th for the hand motion detecting process (for example, the detection threshold value Th1, the success or failure determination threshold value Th2, and the reliability determination threshold value Th3). At this point, the threshold value setting unit 14 sets at least one of these threshold values Th (for example, the reliability determination threshold value Th3) to a value being different depending on the driving mode information.

Next, in step ST28, the image recognition unit 13 executes the hand motion detecting process. In the hand motion detecting process of step ST28, the detection result of the hand feature point detecting process of step ST24 is used, and the threshold values Th set in step ST27 are also used.

If it is determined in the hand posture detecting process in step ST26 that the reliability R of the detection result is greater than the reliability determination threshold value Th3, and if it is determined in the hand motion detecting process in step ST28 that the reliability R of the detection result is greater than the reliability determination threshold value Th3, the gesture recognition unit 17 executes the gesture recognition process in step ST29. In the gesture recognition process of step ST29, the detection result of the hand posture detecting process of step ST26 and the detection result of the hand motion detecting process of step ST28 are used.

Note that if it is determined in the hand area detecting process in step ST22 that the reliability R of the detection result is less than or equal to the reliability determination threshold value Th3, the process of step ST23 and subsequent processes (that is, processes of steps ST23 to ST29) are not executed.

Furthermore, if it is determined in the hand feature point detecting process in step ST24 that the reliability R of the detection result is less than or equal to the reliability determination threshold value Th3, the process of step ST25 and subsequent processes (that is, processes of steps ST25 to ST29) are not executed.

Furthermore, if it is determined that the reliability R of the detection result is less than or equal to the reliability determination threshold value Th3 in at least one of the hand posture detecting process of step ST26 and the hand motion detecting process of step ST28, the process of step ST29 is not executed.

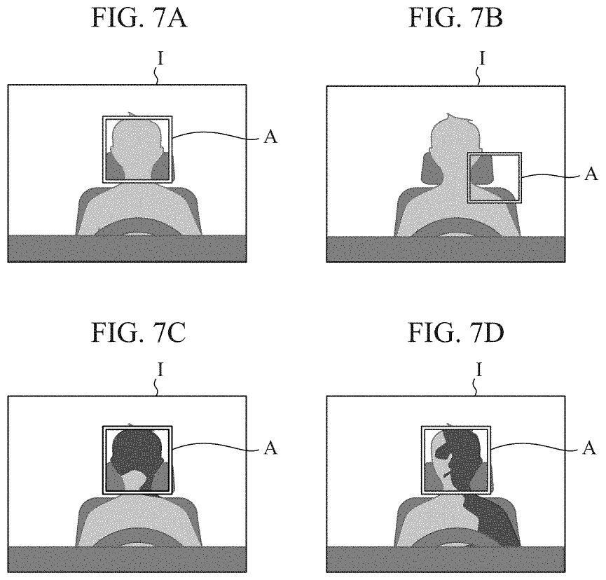

Next, with reference to FIG. 7, a specific example of the reliability determination threshold value Th3 for the face area detecting process will be described. FIGS. 7A to 7D each illustrate an example of a captured image I and a face area A.

In the examples illustrated in FIG. 7, the reliability R of the detection result in the face area detecting process is represented by a value of 0 to 100, and the greater the value is, the higher the reliability of the detection result is. The threshold value setting unit 14 sets the reliability determination threshold value Th3 for the face area detecting process to “60” when the vehicle 1 is set to the manual driving mode. The threshold value setting unit 14 sets the reliability determination threshold value Th3 for the face area detecting process to “40” when the vehicle 1 is set to the autonomous driving mode.

In the examples illustrated in FIG. 7A, the contrast in the face area A is weak, there is no shielding object covering the passenger's face (for example, a passenger's hand or food and drink), and the passenger is not wearing any item additional to the clothes (for example, a mask, a hat or, or a muffler). Therefore, the reliability R is calculated to be a high value (for example, “80”). As a result, when the vehicle 1 is set to the manual driving mode, it is determined that the reliability R is greater than the reliability determination threshold value Th3, and the process of step ST3 is started. Also when the vehicle 1 is set to the autonomous driving mode, it is determined that the reliability R is greater than the reliability determination threshold value Th3, and the process of step ST3 is started.

In the example illustrated in FIG. 7B, a face area A is displaced with respect to the passenger's face, and it is failed to detect the face area A practically. However, it is assumed that detection of the face area A is successful in the face area detecting process, and that the reliability R is calculated. In this case, the reliability R is calculated to be a low value (for example, “30”). As a result, when the vehicle 1 is set to the manual driving mode, it is determined that the reliability R is less than or equal to the reliability determination threshold value Th3, and the process of step ST3 and subsequent processes are not executed. Also when the vehicle 1 is set to the autonomous driving mode, it is determined that the reliability R is less than or equal to the reliability determination threshold value Th3, and the process of step ST3 and subsequent processes are not executed.

In the example illustrated in FIG. 7C, there is strong contrast between the upper half part and the lower half part in the face area A. Due to this contrast, a lower reliability R (e.g. “50”) is calculated as compared to that in the example illustrated in FIG. 7A. As a result, when the vehicle 1 is set to the manual driving mode, it is determined that the reliability R is less than or equal to the reliability determination threshold value Th3, and the process of step ST3 and subsequent processes are not executed. On the other hand, when the vehicle 1 is set to the autonomous driving mode, it is determined that the reliability R is greater than the reliability determination threshold value Th3, and the process of step ST3 is started.

In the example illustrated in FIG. 7D, there is strong contrast between the left half part and the right half part in the face area A. Due to this contrast, a lower reliability R (e.g. “50”) is calculated as compared to that in the example illustrated in FIG. 7A. As a result, when the vehicle 1 is set to the manual driving mode, it is determined that the reliability R is less than or equal to the reliability determination threshold value Th3, and the process of step ST3 and subsequent processes are not executed. On the other hand, when the vehicle 1 is set to the autonomous driving mode, it is determined that the reliability R is greater than the reliability determination threshold value Th3, and the process of step ST3 is started.

The autonomous driving control device 3 may determine whether or not the vehicle 1 is in a state immediately before transition from the autonomous driving mode to the manual driving mode (hereinafter, referred to as the “immediately-before-transition state”) when the vehicle 1 is set in the autonomous driving mode. The threshold value setting unit 14 may set the reliability determination threshold value Th3 to a smaller value, as compared to a case where the vehicle 1 is set to the manual driving mode, only when it is determined that the vehicle 1 is in the immediately-before-transition state under the condition that the vehicle 1 is set to the autonomous driving mode.

Moreover, the autonomous driving control device 3 may switch the driving mode of the vehicle 1 by an operation input to an operation input device (not illustrated) in the vehicle 1. The operation input device includes, for example, a touch panel or a hardware switch.

Alternatively, the autonomous driving control device 3 may switch the driving mode of the vehicle 1 depending on, for example, the position of the vehicle 1 using the information output from a navigation system (not illustrated) for the vehicle 1 (hereinafter referred to as the “navigation information”).

Further, the autonomous driving control device 3 may determine whether or not the vehicle 1 is in the immediately-before-transition state using the navigation information, for example in the following manner. That is, when the vehicle 1 is set to the autonomous driving mode, the navigation information includes information indicating the position of the vehicle 1 and information indicating the position of a point at which the vehicle 1 is to be switched from the autonomous driving mode to the manual driving mode (hereinafter referred to as a “switch target point”). The autonomous driving control device 3 determines that the vehicle 1 is in the immediately-before-transition state when the distance of the route from the position of the vehicle 1 to the switch target point is less than a predetermined distance (for example, 100 meters).

Moreover, the autonomous driving control device 3 may switch the driving mode of the vehicle 1 depending on, for example, the type of the road using a signal received by an onboard device (not illustrated) mounted on the vehicle 1. For example, the autonomous driving control device 3 may set the vehicle 1 to the autonomous driving mode when the vehicle 1 is traveling on a highway, and set the vehicle 1 to the manual driving mode when the vehicle 1 is traveling on a general road.

Further, the autonomous driving control device 3 may determine whether or not the vehicle 1 is in the immediately-before-transition state using a signal received by an onboard device, for example in the following manner. That is, the autonomous driving control device 3 determines that the vehicle 1 is in the immediately-before-transition state when the onboard device for the electronic toll collection system (ETC) receives a signal indicating that the vehicle 1 exits from the highway (that is, a signal indicating that the vehicle 1 is intending to enter a general road).

Moreover, the threshold value setting unit 14 may set a threshold value Th other than the reliability determination threshold value Th3 to a value being different depending on the driving mode information. For example, the threshold value setting unit 14 may set each of the detection threshold values Th1 to a value being different depending on the driving mode information. The threshold value setting unit 14 may also set each of the success or failure determination threshold values Th2 to a value being different depending on the driving mode information.

The passenger state determining processing by the passenger state determining unit 15 may not include the dozing state determining process (that is, may include only the inattentive state determining process). In this case, the image recognition processing by the image recognition unit 13 may not include the eye opening degree detecting process.

Moreover, the passenger state determining processing by the passenger state determining unit 15 may not include the inattentive state determining process (that is, may include only the dozing state determining process). In this case, the image recognition processing by the image recognition unit 13 may not include the face orientation detecting process.

Furthermore, the gesture recognition process by the gesture recognition unit 17 may not use the result of the hand motion detecting process (that is, may include only the result of the hand posture detecting process). In this case, the image recognition processing by the image recognition unit 13 may not include the hand posture detecting process.

In addition, the gesture recognition process by the gesture recognition unit 17 may not use the result of the hand posture detecting process (that is, may include only the result of the hand motion detecting process). In this case, the image recognition processing by the image recognition unit 13 may not include the hand motion detecting process.

The passenger state determining unit 15 may be installed outside the image processing device 100. That is, the image recognition unit 13, the threshold value setting unit 14, and the gesture recognition unit 17 are included in the main part of the image processing device 100.

Moreover, the gesture recognition unit 17 may be installed outside the image processing device 100. That is, the image recognition unit 13, the threshold value setting unit 14, and the passenger state determining unit 15 may be included in the main part of the image processing device 100.

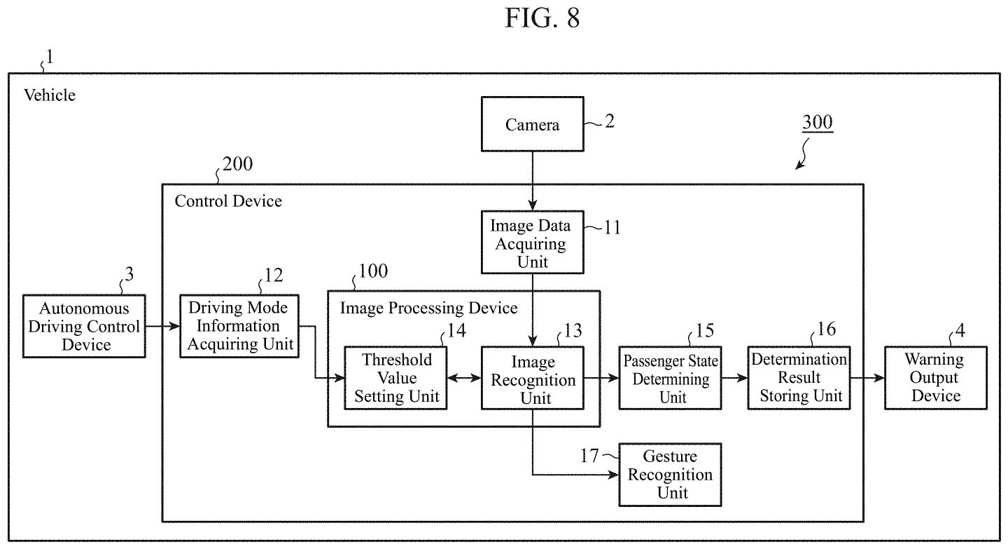

Furthermore, the passenger state determining unit 15 and the gesture recognition unit 17 may be installed outside the image processing device 100. That is, the image recognition unit 13 and the threshold value setting unit 14 may be included in the main part of the image processing device 100. A block diagram in this case is illustrated in FIG. 8.

As described above, the image processing device 100 according to the first embodiment includes: the image recognition unit 13 for executing the image recognition processing on an image captured by the camera 2 for imaging a vehicle interior; and the threshold value setting unit 14 for setting at least one threshold value Th among one or more threshold values Th for the image recognition processing to a value being different depending on the driving mode information. As a result, image recognition processing in accordance with the driving mode of the vehicle 1 can be implemented.

The driving mode information indicates whether the vehicle 1 is set to the manual driving mode or the autonomous driving mode, and, when the vehicle 1 is set to the autonomous driving mode, the threshold value setting unit 14 sets the reliability determination threshold value Th3 to a smaller value as compared to a case where the vehicle 1 is set to the manual driving mode. In other words, the threshold value setting unit 14 sets the reliability determination threshold value Th3 to a greater value, when the vehicle 1 is set to the manual driving mode, than that in a case where the vehicle 1 is set to the autonomous driving mode. As a result, it is possible to improve, when the vehicle 1 is set to the manual driving mode, the accuracy of the passenger state determining processing and reduce the number of times the passenger state determining processing is executed (that is, execution frequency), and to reduce, when the vehicle 1 is set to the autonomous driving mode, the accuracy of the passenger state determining processing and increase the number of times the passenger state determining processing is executed (that is, execution frequency). As a result, in the manual driving mode, it is possible to prevent excessive detection of an abnormal state and to reduce output of unnecessary warnings. Further, in the autonomous driving mode, it is possible to prevent detection failures of an abnormal state and not to miss an abnormal state.

In particular, even in a case where it is not determined whether or not the vehicle 1 is in the immediately-before-transition state, that is, in a case where it is unknown whether or not the vehicle 1 is in the immediately-before-transition state and it is unknown when the vehicle 1 will be switched from the autonomous driving mode to the manual driving mode, it is possible to assume that the vehicle 1 is in the immediately-before-transition state if the vehicle 1 is set to the autonomous driving mode, and to thereby prevent detection failures of an abnormal state. As a result, it is possible to switch from the autonomous driving mode to the manual driving mode at any time when the switching is required, thereby making it possible not to miss an abnormal state.

### Second Embodiment

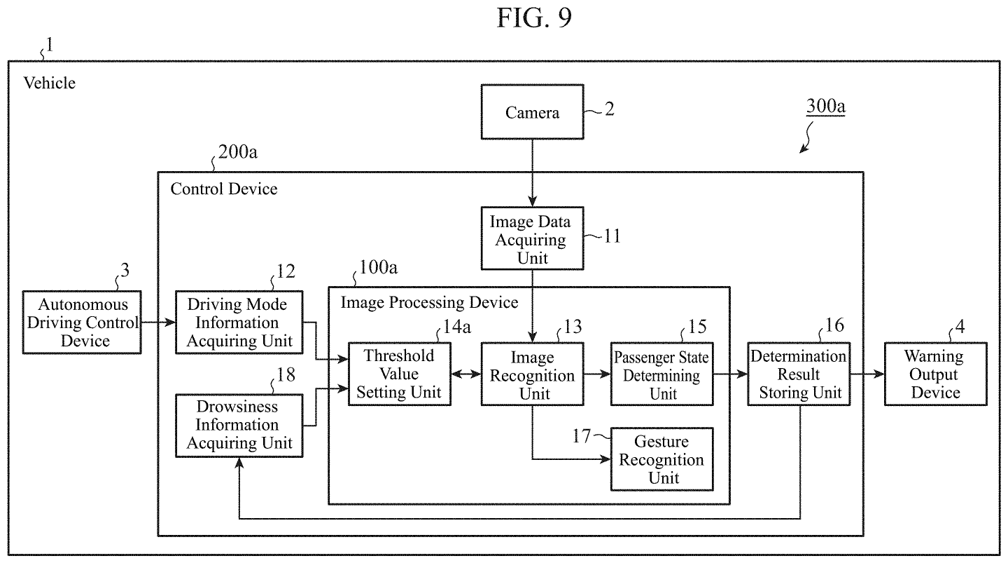

FIG. 9 is a block diagram illustrating a state in which an image processing system according to a second embodiment is installed in a vehicle. An image processing system 300a according to the second embodiment will be described with reference to FIG. 9. Note that in FIG. 9 the same symbol is given to a block similar to that illustrated in FIG. 1, and description thereof is omitted.

As described in the first embodiment, a determination result storing unit 16 stores determination result information. The determination result information includes information indicating the drowsiness level of the passenger (hereinafter referred to as “drowsiness information”) calculated in the dozing state determining process.

A drowsiness information acquiring unit 18 acquires the drowsiness information stored in the determination result storing unit 16 from the determination result storing unit 16. The drowsiness information acquiring unit 18 outputs the acquired drowsiness information to a threshold value setting unit 14a.

The image recognition unit 13 executes multiple types of image recognition processing on the captured image using the image data output by the image data acquiring unit 11. In each of the multiple of types of image recognition processing, one or more threshold values Th are used. The threshold value setting unit 14a sets these threshold values Th. Specific examples of the image recognition processing and the threshold values Th are similar to those described in the first embodiment, and thus redundant description will be omitted.

Here, the threshold value setting unit 14a sets at least one threshold value Th (for example, the reliability determination threshold value Th3) among one or more threshold values Th (for example, the detection threshold value Th1, the success or failure determination threshold value Th2, and the reliability determination threshold value Th3) to a value being different depending on the driving mode information output by the driving mode information acquiring unit 12 and the drowsiness information output from the drowsiness information acquiring unit 18.

Specifically, for example in a case where the vehicle 1 is set to the autonomous driving mode, the threshold value setting unit 14a sets the reliability determination threshold value Th3 to a smaller value than that in a case where the vehicle 1 is set to the manual driving mode. Furthermore, in each of these cases, the threshold value setting unit 14a sets the reliability determination threshold value Th3 to a smaller value when the drowsiness level indicated by the drowsiness information is greater than or equal to a predetermined level (hereinafter referred to as “reference level”), as compared to a case where the drowsiness level indicated by the drowsiness information is less than the reference level. That is, the reliability determination threshold values Th3 are each selectively set to one of four values.

The image recognition unit 13, the threshold value setting unit 14a, the passenger state determining unit 15, and the gesture recognition unit 17 are included in the main part of the image processing device 100a. The image data acquiring unit 11, the driving mode information acquiring unit 12, the determination result storing unit 16, the drowsiness information acquiring unit 18, and the image processing device 100a are included in the main part of the control device 200a. The camera 2 and the control device 200a are included in the main part of the image processing system 300a.

Since a hardware configuration of the main part of the control device 200a is similar to that described with reference to FIG. 2 in the first embodiment, illustration and description thereof are omitted. That is, the function of each of the threshold value setting unit 14a and the drowsiness information acquiring unit 18 may be implemented by the processor 31 and the memory 32, or may be implemented by the processing circuit 34.

Since the operation of the image processing device 100a is similar to that described with reference to the flowchart of FIGS. 3 to 6 in the first embodiment, illustration and description thereof are omitted. Note that the threshold value setting unit 14a sets at least one threshold value Th (e.g. reliability determination threshold value Th3) to a value being different depending on the driving mode information and the drowsiness information in each of steps ST1, ST3, ST5, ST8, ST21, ST23, ST25, and ST27.

Note that the threshold value setting unit 14a is only required to set at least one threshold value Th (for example, the reliability determination threshold value Th3) to a value being different depending on the driving mode information and the drowsiness information. The method of setting the threshold values Th by the threshold value setting unit 14a is not limited to the above specific examples.

For example, a reliability determination threshold value Th3 may be selectively set to one of two values, selectively set to one of three values, or selectively set to one of five or more values depending on the driving mode of the vehicle 1 and the drowsiness level of the passenger.

In addition, the image processing device 100a, the control device 200a, and the image processing system 300a can employ various modifications similar to those described in the first embodiment.

As described above, in the image processing device 100a according to the second embodiment, the threshold value setting unit 14a sets at least one threshold value Th to a value being different depending on the driving mode information and the drowsiness information. This makes it possible to implement image recognition processing in accordance with the driving mode of the vehicle 1 and the drowsiness level of the passenger.

The drowsiness information indicates the drowsiness level of the passenger, and the threshold value setting unit 14a sets the reliability determination threshold value Th3 to a smaller value when the drowsiness level is greater than or equal to the reference level, as compared to a case where the drowsiness level is less than the reference level. As a result, when the drowsiness level of the passenger is low (that is, when the passenger is awake), it is possible to reduce the number of times the passenger state determining processing such as the dozing state determining process is executed. On the other hand, when the drowsiness level of the passenger is high (that is, when the awakening level of the passenger is low), it is possible to increase the number of times the passenger state determining processing such as the dozing state determining process is executed.

### Third Embodiment

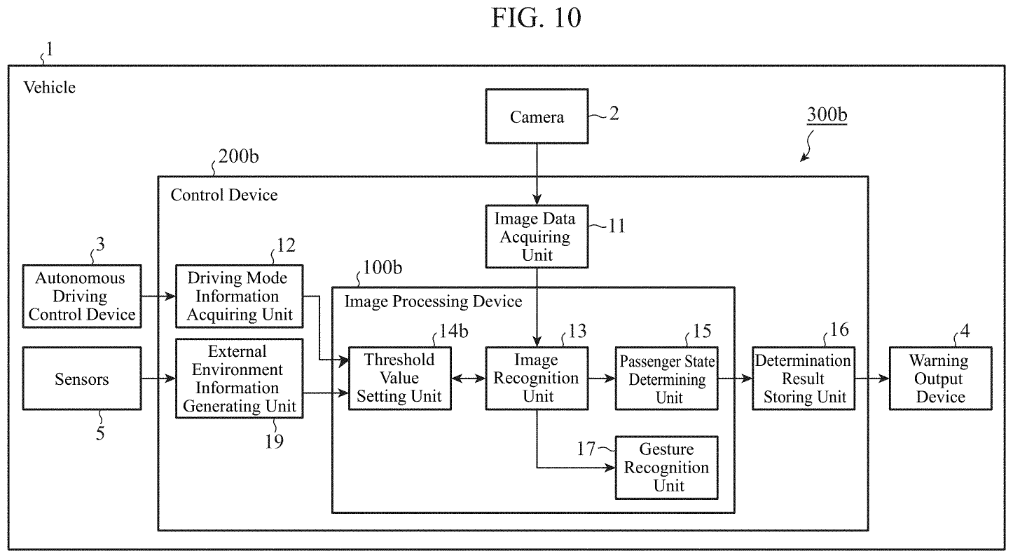

FIG. 10 is a block diagram illustrating a state in which an image processing system according to a third embodiment is installed in a vehicle. An image processing system 300b according to the third embodiment will be described with reference to FIG. 10. Note that in FIG. 10 the same symbol is given to a block similar to that illustrated in FIG. 1, and description thereof is omitted.

An external environment information generating unit 19 generates information regarding the external environment of a vehicle 1 (hereinafter referred to as “external environment information”). The external environment information includes, for example, at least one of information indicating the weather around the vehicle 1 (more specifically, the amount of rainfall or snowfall), information indicating the current time zone, information indicating the occurrence of traffic congestion around the vehicle 1, and information indicating an inter-vehicle distance between the vehicle 1 and another vehicle traveling around the vehicle 1. The external environment information generating unit 19 outputs the generated external environment information to a threshold value setting unit 14b.

At least one of an image captured by the camera 2 and a detection value by sensors 5 is used for generation of the external environment information. In FIG. 10, a line connecting between the camera 2 and the external environment information generating unit 19 (or between the image data acquiring unit 11 and the external environment information generating unit 19) is not illustrated. The sensors 5 include, for example, at least one of an ultrasonic sensor, a millimeter wave radar, and a laser radar.

The image recognition unit 13 executes multiple types of image recognition processing on the captured image using the image data output by the image data acquiring unit 11. Each of the multiple of types of image recognition processing uses one or more threshold values Th. The threshold value setting unit 14b sets these threshold values Th. Specific examples of the image recognition processing and the threshold values Th are similar to those described in the first embodiment, and thus redundant description will be omitted.

Here, the threshold value setting unit 14b sets at least one threshold value Th (for example, the reliability determination threshold value Th3) among one or more threshold values Th (for example, the detection threshold value Th1, the success or failure determination threshold value Th2, and the reliability determination threshold value Th3) to a value being different depending on the driving mode information output by the driving mode information acquiring unit 12 and the external environment information output from the external environment information generating unit 19.

Specifically, for example, let us assumed that the external environment information includes information indicating the amount of rainfall or the amount of snowfall around the vehicle 1 (hereinafter collectively referred to as the “precipitation amount”). In a case where the vehicle 1 is set to the autonomous driving mode, the threshold value setting unit 14b sets the reliability determination threshold value Th3 to a smaller value than that in a case where the vehicle 1 is set to the manual driving mode. In each of these cases, the threshold value setting unit 14b sets the reliability determination threshold value Th3 to a smaller value when the precipitation amount indicated by the external environment information is greater than or equal to a predetermined amount (hereinafter referred to as “reference amount”, for example, 0.5 mm/h), as compared to a case where the precipitation amount indicated by the external environment information is less than the reference amount. That is, the reliability determination threshold values Th3 are each selectively set to one of four values.

The image recognition unit 13, the threshold value setting unit 14b, the passenger state determining unit 15, and the gesture recognition unit 17 are included in the main part of the image processing device 100b. The image data acquiring unit 11, the driving mode information acquiring unit 12, the determination result storing unit 16, the external environment information generating unit 19, and the image processing device 100b are included in the main part of the control device 200b. The camera 2 and the control device 200b are included in the main part of the image processing system 300b.

Since a hardware configuration of the main part of the control device 200b is similar to that described with reference to FIG. 2 in the first embodiment, illustration and description thereof are omitted. That is, the function of each of the threshold value setting unit 14b and the external environment information generating unit 19 may be implemented by the processor 31 and the memory 32, or may be implemented by the processing circuit 34.

Since the operation of the image processing device 100b is similar to that described with reference to the flowchart of FIGS. 3 to 6 in the first embodiment, illustration and description thereof are omitted. Note that the threshold value setting unit 14b sets at least one threshold value Th (e.g. reliability determination threshold value Th3) to a value being different depending on the driving mode information and the external environment information in each of steps ST1, ST3, ST5, ST8, ST21, ST23, ST25, and ST27.

The threshold value setting unit 14b is only required to set at least one threshold value Th (for example, the reliability determination threshold value Th3) to a value being different depending on the driving mode information and the external environment information. The method of setting the threshold values Th by the threshold value setting unit 14b is not limited to the above specific examples.

For example in a case where the external environment information includes information indicating the current time zone, the threshold value setting unit 14b may set the reliability determination threshold value Th3 to a value being different depending on to which time zone the current time zone belongs among the morning time zone, the daytime time zone, the evening time zone, or the night time zone.

Further, for example in a case where the external environment information includes information indicating the occurrence of traffic congestion around the vehicle 1, the threshold value setting unit 14b may set the reliability determination threshold value Th3 to a value being different depending on whether or not traffic congestion is occurring around the vehicle 1.

Moreover, for example in a case where the external environment information includes information indicating the inter-vehicle distance between the vehicle 1 and another vehicle traveling around the vehicle 1, the threshold value setting unit 14b may set the reliability determination threshold value Th3 to a value being different depending on whether or not the inter-vehicle distance indicated by the external environment information is greater than or equal to a predetermined distance (hereinafter referred to as the “reference distance”).

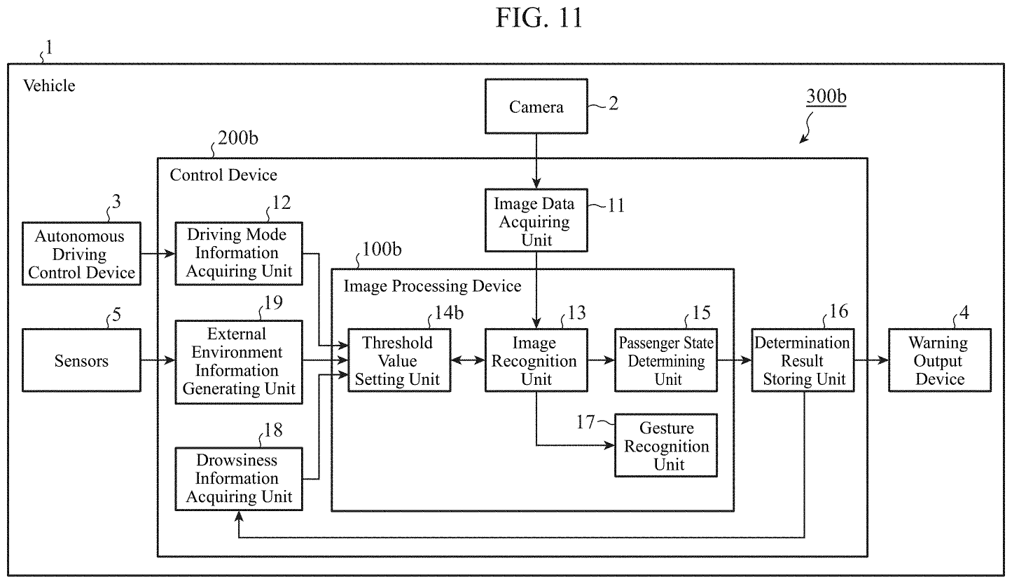

As illustrated in FIG. 11, the control device 200b may also include a drowsiness information acquiring unit 18. In this case, the threshold value setting unit 14b may set at least one threshold value Th (for example, the reliability determination threshold value Th3) to a value being different depending on the driving mode information, the drowsiness information, and the external environment information.

In addition, the image processing device 100b, the control device 200b, and the image processing system 300b can employ various modifications similar to those described in the first embodiment.

As described above, in the image processing device 100b according to the third embodiment, the threshold value setting unit 14b sets at least one threshold value Th to a value being different depending on the driving mode information and the external environment information. This makes it possible to implement image recognition processing in accordance with the driving mode of the vehicle 1 and the external environment of the vehicle 1.

Further, in a case where the external environment information indicates the precipitation amount around the vehicle 1, the threshold value setting unit 14b sets the reliability determination threshold value Th3 to a smaller value when the precipitation amount is greater than or equal to the reference amount as compared to a case where the precipitation amount is less than the reference amount. As a result, for example, when it is raining or snowing around the vehicle 1, it is possible to increase the number of times the passenger state determining processing is executed. On the other hand, when there is no rain nor snow around the vehicle 1, it is possible to improve the accuracy of the passenger state determining processing while the number of times the passenger state determining processing is executed is reduced.

Note that the present invention may include a flexible combination of the embodiments, a modification of any component of the embodiments, or an omission of any component in the embodiments within the scope of the present invention.

### INDUSTRIAL APPLICABILITY

An image processing device, an image processing method, and an image processing system of the present invention can be used, for example, for determining whether or not a passenger of a vehicle is in an abnormal state, or for recognizing a hand gesture by a passenger of the vehicle.

### REFERENCE SIGNS LIST

1: vehicle, 2: camera, 3: autonomous driving control device, 4: warning output device, 5: sensors, 11: image data acquiring unit, 12: driving mode information acquiring unit, 13: image recognition unit, 14, 14a, 14b: threshold value setting unit, 15: passenger state determining unit, 16: determination result storing unit, 17: gesture recognition unit, 18: drowsiness information acquiring unit, 19: external environment information generating unit, 31: processor, 32: memory, 33: memory, 34: processing circuit, 100, 100a, 100b: image processing device, 200, 200a, 200b: control device, 300, 300a, 300b: image processing system

1. An image processing device comprising processing circuitry
to execute image recognition processing on an image captured by a camera for imaging an interior of a vehicle; and
to set at least one threshold value among one or more threshold values to be used for the image recognition processing to a value being different depending on driving mode information which indicates whether the vehicle is set to a first driving mode or a second driving mode,
wherein the at least one threshold value is set to a smaller value when the vehicle is set to the first driving mode than the at least one threshold value when the vehicle is set to the second driving mode, and
the processing circuitry determines whether or not processing using a detection result of the image recognition processing is to be executed on a basis of the at least one threshold value.

2. The image processing device according to claim 1,
wherein the at least one threshold value includes a reliability determination threshold value to be compared with a reliability of the detection result,
in the image recognition processing, in a case where the reliability is determined to be higher than the reliability determination threshold value, the processing using the detection result is executed, and in a case where the reliability is determined to be equal to or smaller than the reliability determination threshold value, the processing using the detection result is not executed.

3. The image processing device according to claim 2,
wherein the processing circuitry executes another type of image recognition processing using the detection result in a case where the reliability is determined to be greater than the reliability determination threshold value in the image recognition processing.

4.-9. (canceled)

10. The image processing device according to claim 2, wherein the processing circuitry executes a passenger state determining processing using the detection result in a case where the reliability is determined to be greater than the reliability determination threshold value in the image recognition processing.

11. The image processing device according to claim 10, wherein the image recognition processing is processing to detect an eye opening degree of a passenger, and the passenger state determining processing is processing to determine whether or not the passenger is in a dozing state.

12. The image processing device according to claim 10, wherein the image recognition processing is processing to detect an angle of a face orientation of a passenger, and the passenger state determining processing is processing to determine whether or not the passenger is in an inattentive state.

13. The image processing device according to claim 2, wherein the processing circuitry executes a gesture recognition process using the detection result in a case where the reliability is determined to be greater than the reliability determination threshold value in the image recognition processing.

14. The image processing device according to claim 13, wherein the image recognition processing is processing to detect a posture of a hand of a passenger.

15. The image processing device according to claim 13, wherein the image recognition processing is processing to detect a motion of a hand of a passenger.

16. The image processing device according to claim 2,
wherein the first driving mode and the second driving mode indicated by the driving mode information are a manual driving mode and an autonomous driving mode, respectively, and
when the vehicle is set to the autonomous driving mode, the processing circuitry sets the reliability determination threshold value to a smaller value as compared to the reliability determination threshold value in a case where the vehicle is set to the manual driving mode.

17. The image processing device according to claim 2,
wherein the first driving mode and the second driving mode indicated by the driving mode information are a manual driving mode and an autonomous driving mode, respectively, and
when the vehicle is set to the autonomous driving mode and when the vehicle is determined to be in a state immediately before transition from the autonomous driving mode to the manual driving mode, the processing circuitry sets the reliability determination threshold value to a smaller value as compared to the reliability determination threshold value in a case where the vehicle is set to the manual driving mode.

18. The image processing device according to claim 16,
wherein the driving mode information is output by the autonomous driving control device, and
the autonomous driving control device switches a driving mode of the vehicle by an operation input to an operation input device.

19. The image processing device according to claim 17,
wherein the driving mode information is output by the autonomous driving control device, and
the autonomous driving control device determines whether or not the vehicle is in the state immediately before transition using navigation information.

20. The image processing device according to claim 17,
wherein the driving mode information is output by the autonomous driving control device, and
the autonomous driving control device determines whether or not the vehicle is in the state immediately before transition using a signal received by an onboard device.

21. The image processing device according to claim 1, wherein the processing circuitry sets the at least one threshold value to a value being different depending on the driving mode information and drowsiness information.

22. The image processing device according to claim 2,
wherein the processing circuitry sets the at least one threshold value to a value being different depending on the driving mode information and drowsiness information,
the drowsiness information indicates a drowsiness level of a passenger, and
in a case where the drowsiness level is greater than or equal to a reference level, the processing circuitry sets the reliability determination threshold value to a smaller value as compared to the reliability determination threshold value in a case where the drowsiness level is less than the reference level.

23. The image processing device according to claim 1, wherein the processing circuitry sets the at least one threshold value to a value being different depending on the driving mode information and external environment information.

24. The image processing device according to claim 2,
wherein the processing circuitry sets the at least one threshold value to a value being different depending on the driving mode information and the external environment information,
the external environment information indicates a precipitation amount around the vehicle, and
the processing circuitry sets the reliability determination threshold value to a smaller value when the precipitation amount is greater than or equal to a reference amount as compared to the reliability determination threshold value in a case where the precipitation amount is less than the reference amount.

25. An image processing method comprising the steps of:
executing image recognition processing on an image captured by a camera for imaging an interior of a vehicle; and
setting at least one threshold value among one or more threshold values to be used for the image recognition processing to a value being different depending on driving mode information which indicates whether the vehicle is set to a first driving mode or a second driving mode,
wherein the at least one threshold value is set to a smaller value when the vehicle is set to the first driving mode than the at least one threshold value when the vehicle is set to the second driving mode, and
the processing circuitry determines whether or not processing using a detection result of the image recognition processing is to be executed on a basis of the at least one threshold value.

26. An image processing system comprising:
a camera imaging an interior of a vehicle; and
an image processing device comprising a processing circuitry to execute image recognition processing on an image captured by the camera; and to set at least one threshold value among one or more threshold values to be used for the image recognition processing to a value being different depending on driving mode information which indicates whether the vehicle is set to a first driving mode or a second driving mode,
wherein the at least one threshold value is set to a smaller value when the vehicle is set to the first driving mode than the at least one threshold value when the vehicle is set to the second driving mode, and
the processing circuitry determines whether or not processing using a detection result of the image recognition processing is to be executed on a basis of the at least one threshold value.
